(19) United States
(12) Patent Application Publication
(10) Pub. No.: US 2024/0067263 A1
(43) Pub. Date: Feb. 29, 2024

(54) Method for Reducing an Energy Demand and/or Energy Consumption by a Vehicle

(71) Applicant: Robert Bosch GmbH, Stuttgart (DE)

(72) Inventors: Christian Riese, Stuttgart (DE); Jonas Coesfeld, Karlsruhe (DE); Matthias Ehrmann, Neuhausen (DE); Thomas Kurz, Roemerberg (DE); Tobias Ritz, Leonberg (DE)

(21) Appl. No.: 18/452,381

(22) Filed: Aug. 18, 2023

(30) Foreign Application Priority Data
Aug. 25, 2022 (DE) 10 2022 208 777.1

(51) Int. Cl. B62D 6/00

(52) U.S. Cl. CPC B62D 6/00

(57) ABSTRACT

A method is for reducing an energy demand and/or energy consumption by a vehicle, in particular a motor vehicle. The vehicle includes a steering system having at least two wheel steering angle actuators for changing a respective wheel steering angle of a vehicle wheel on an individual wheel basis, and a vehicle sensor system for driving situation recognition. In at least one operating state, in which a predefined driving situation is identified using the vehicle sensor system, a power consumption by at least one wheel steering angle actuator is reduced in order to reduce the energy demand and/or energy consumption, in particular such that the power consumption by the at least one wheel steering angle actuator is below a power consumption by the at least one wheel steering angle actuator planned for in the identified predefined driving situation.

This application claims priority under 35 U.S.C. § 119 to patent application no. DE 10 2022 208 777.1, filed on Aug. 25, 2022 in Germany, the disclosure of which is incorporated herein by reference in its entirety.

The disclosure relates to a method for reducing an energy demand and/or energy consumption by a vehicle. The disclosure also relates to a computing unit for performing such a method and a vehicle comprising such a computing unit.

### BACKGROUND

Vehicles with conventional steering systems in which a steering handle, e.g., in the form of a steering wheel, is mechanically connected to a steering gear via a steering column are known from the prior art. Also known are vehicles with steer-by-wire steering systems, which do not require a direct mechanical connection between a steering handle and steered vehicle wheels, and in which a steering command is only transmitted electrically. To change a wheel steering angle of a vehicle wheel, steer-by-wire steering systems comprise either a wheel steering angle actuator designed as a central actuator or multiple wheel steering angle actuators designed as single wheel steering actuators. One disadvantage of single wheel steering actuators compared to a central actuator is that they exhibit a higher overall energy demand or energy consumption. For example, in contrast to central actuators, single wheel steering actuators must provide actuator forces both in the case of symmetrically acting external forces, e.g. during straight travel, and in the case of asymmetrically acting external forces, e.g. during cornering, in order to maintain a desired target position. Doing so inevitably leads to increased power consumption by the single wheel steering actuators.

The object of the disclosure is therefore in particular to provide a method and a vehicle having improved properties with respect to an efficiency. This object is achieved as disclosed herein.

### SUMMARY

A method, in particular a computer-implemented method, is proposed for reducing the energy demand and/or energy consumption by a vehicle, the vehicle comprising a steering system having at least two wheel steering angle actuators used for changing a respective wheel steering angle of a vehicle wheel on an individual wheel basis, and a vehicle sensor system used for driving situation recognition, whereby, in at least one operating state, in particular an operating state different from a fault operating state, a predefined driving situation, preferably from a group of multiple predefined driving situations, is identified by means of the vehicle sensor system in order to reduce, in particular intentionally, the energy demand and/or energy consumption for power input by at least one wheel steering angle actuator. In particular, the at least one wheel steering angle actuator is actuated such that the power consumption by the at least one wheel steering angle actuator is reduced and is below a power consumption by the at least one wheel steering angle actuator planned for in the driving situation. In this case, the wheel steering angle actuators are designed in particular as single wheel steering actuators. In principle, in the operating state, or in at least one further operating state in which a corresponding predefined driving situation is identified by means of the vehicle sensor system, a power consumption by multiple wheel steering angle actuators, e.g., of at least two, of at least three, and/or of at least four wheel steering angle actuators, can also be reduced, in particular intentionally, in order to reduce the energy demand and/or energy consumption. This design is able to improve an efficiency, particularly an energy efficiency, a component efficiency, a power efficiency, and/or a cost efficiency. In addition, a power consumption by the wheel steering angle actuator can be dynamically adjusted depending on the driving situation. In addition, a service life and/or durability of the vehicle can advantageously be improved.

Preferably, the vehicle is designed as a motor vehicle and in particular comprises the steering system and the vehicle sensor system, which is provided in order to identify at least one, in particular current and/or future, driving situation. The vehicle sensor system can for this purpose comprise, e.g., at least one sensor element (in particular electrical, magnetic and/or optical), a navigation system, e.g. having a GPS module, and/or a communication module for wireless communication with an external computer network, e.g. a cloud network. Furthermore, the steering system is designed as a steer-by-wire steering system in which a steering command is advantageously transmitted only electrically to the vehicle wheels. In this case, the steering system comprises the wheel steering angle actuators used for changing a respective wheel steering angle on an individual wheel basis and, advantageously, an operating unit mechanically separate from the wheel steering angle actuators. The term “operating unit” is in particular understood to mean input unit that can be operated by a driver in order to actuate the wheel steering angle actuators. In particular, the operating unit can comprise a steering handle, e.g., in the form of a steering wheel, and advantageously a feedback actuator, e.g., in the form of an electric motor used for generating a steering resistance and/or a restoring torque to the steering handle. The term “wheel steering angle actuator” is in particular understood to mean an actuator unit operatively connected to a vehicle wheel and provided for transmitting a steering command to the vehicle wheel by changing a wheel steering angle of the vehicle wheel, and thereby advantageously controlling at least one orientation of the vehicle wheel and/or influencing one direction of travel of the vehicle. For this purpose, the wheel steering angle actuator advantageously comprises at least one steering actuator element, e.g. in the form of a gear rack, and at least one steering actuator operatively connected to the steering actuator element, e.g. in the form of an electric motor. The at least two wheel steering angle actuators can in this case be associated with a vehicle axle designed as a front axle, or to a further vehicle axle designed as a rear axle. In principle, a vehicle can also comprise more than two wheel steering angle actuators, e.g., four wheel steering angle actuators designed as single wheel steering actuators, in which case two wheel steering angle actuators are associated with each vehicle axle.

The vehicle further comprises a computing unit, which is provided to perform the method for reducing the energy demand and/or energy consumption by the vehicle. The term “computing unit” is in particular understood to mean an electrical and/or electronic unit which comprises an information input means, an information processor, and an information output means. Advantageously, the computing unit further comprises at least one processor, at least one operating memory, at least one input and/or output means, at least one operating program, at least one control routine, at least one calculation routine, at least one identification routine, at least one evaluation routine, and/or at least one actuation routine. In particular, the computer unit is provided for actuating at least one wheel steering angle actuator, and preferably all wheel steering angle actuators. In this context, the computing unit is provided at least for reducing a power consumption by at least one wheel steering angle actuator in order to reduce the energy demand and/or energy consumption, in particular such that the power consumption by the at least one wheel steering angle actuator is below a power consumption by the at least one wheel steering angle actuator planned for in the driving situation. In addition, the computing unit can be provided in cooperation with the vehicle sensor system to identify a driving situation, in particular a current and/or future driving situation, and to compare it with at least one predefined driving situation. The predefined driving situation and/or the predefined driving situations can, e.g., be stored in the operating memory. Furthermore, the computing unit can in this context also be provided to identify and evaluate a vehicle trajectory of the vehicle, in particular a trajectory ahead and/or a future trajectory. The computing unit is in this case preferably integrated into a control device of the vehicle, e.g., a central vehicle control device, or a control device of the steering system, in particular in the form of a steering control device. The term “provided” is in particular understood to mean specifically programmed, designed, and/or equipped. The phrase “an object being provided for a specific function” is in particular understood to mean that the object fulfills and/or performs this specific function in at least one application and/or operating state.

The power consumption by the at least one wheel steering angle actuator could be reduced in the operating state by, e.g., at least 10%, by at least 50%, or by at least 80%, so that at least a minimum steering functionality of the wheel steering angle actuator is maintained. Preferably, however, it is proposed that, in the operating state, active actuation of the at least one wheel steering angle actuator is omitted, and/or the at least one wheel steering angle actuator is at least temporarily deactivated, thus achieving particularly high efficiency. In this context, a motor torque of the at least one wheel steering angle actuator, in particular the steering actuator, can be set to zero. Alternatively or additionally, the at least one wheel steering angle actuator can be, e.g., set to a standby mode and/or standby operation. By exploiting chassis kinematics, in particular in the form of castering, it is then possible to ensure that the non-actuated or deactivated wheel steering angle actuator “follows along”.

It is further proposed that, in the operating condition, at least one environmental variable and/or at least one vehicle operating variable is monitored and evaluated in order to identify a reactivation condition. Preferably, the environmental variable and/or operating variable being monitored and/or evaluated in particular are selected and/or varied as a function of the respective driving situation. The reactivation condition is then preferably used to reactivate a normal operation of the at least one wheel steering angle actuator. For example, camera data and/or road map data can be used as an environmental variable, whereas an operation of a vehicle pedal of the vehicle, an actuation of a parking brake of the vehicle, a detection signal of an inertial sensor system of the vehicle, a vehicle speed, a steering handle deflection, a wheel steering angle, a gear rack position of the wheel steering angle actuator, and/or a rotational wheel speed signal can, e.g., be used as an operating variable. Furthermore, the environmental variable and/or the operating variable can be identified by means of the vehicle sensor system and/or an additional sensor system of the vehicle in particular. In this way, in particular, a high level of operational reliability, as well as an advantageous anticipatory reactivation of the at least one wheel steering angle actuator can be achieved.

Particularly preferably, it is also proposed that, during reactivation of normal operation by the at least one wheel steering angle actuator and, in particular, of a position regulator used to actuate the at least one wheel steering angle actuator, a rate of increase of an engine torque is temporarily limited, in particular until a target position is reached. Alternatively, however, a gain-scheduling approach could be used when reactivating the normal operation by the at least one wheel steering angle actuator. Doing so can in particular prevent driver annoyance when reactivating the normal operation by the at least one wheel steering angle actuator.

It is also proposed that, in the operating state, a steering ratio, in particular a virtual one, between a steering handle of the steering system and the wheel steering angle actuators is adapted such that a steering behavior or driving behavior remains unchanged. Doing so can in particular provide functionality that is advantageously unobtrusive to a driver. In this case, the steering ratio defines in particular a correlation between a steering command at the steering handle and a wheel steering angle of the vehicle wheel or wheels.

It is further proposed that at least one further environmental variable and/or at least one further vehicle operating variable be taken into account when reducing the power consumption by the at least one wheel steering angle actuator. Preferably, the further environmental variable and/or further operating variable are thereby selected and/or varied depending on the respective driving situation. For example, camera data and/or road map data can be used as a further environmental variable, whereas an actuation of a vehicle pedal of the vehicle, an actuation of a parking brake of the vehicle, a detection signal of an inertial sensor system of the vehicle, a vehicle speed, a steering handle deflection, a wheel steering angle, a gear rack position of the wheel steering angle actuators, and/or a rotational wheel speed signal can, e.g., be used as a further operating variable. In principle, the further environmental variable can also be identical to the environmental variable, and/or the further operational variable can be identical to the operational variable.

According to a further embodiment, it is proposed that a course of a preceding route of travel is taken into account when reducing the power consumption by the at least one wheel steering angle actuator, in which case an efficiency is in particular further improved, and a constant switching of the at least one wheel steering angle actuator can be omitted. In addition, a course of the preceding route of travel can also be taken into account when reactivating the normal operation by the at least one wheel steering angle actuator in order to achieve a particularly anticipatory reactivation.

It is further proposed that a cornering direction be taken into account when reducing the power consumption by the at least one wheel steering angle actuator. In this context, it is conceivable to, e.g., reduce power consumption only in the case of an inside-curve or an outside-curve wheel steering angle actuator. In addition, a cornering direction can also be taken into account when reactivating the normal operation of the at least one wheel steering angle actuator. In this way, a particularly high degree of flexibility and/or variability can be achieved.

Preferably, it is further proposed that a vehicle speed and/or a lateral acceleration of the vehicle is taken into account when reducing the power consumption by the at least one wheel steering angle actuator. In this context, the power consumption by the at least one wheel steering angle actuator can, e.g., be only below or above a predefined limit vehicle speed and/or limit lateral acceleration. In addition, a vehicle speed and/or a lateral acceleration of the vehicle can also be taken into account when reactivating the normal operation of the at least one wheel steering angle actuator. By taking into account the vehicle speed and/or the lateral acceleration of the vehicle, safety-critical driving situations can be advantageously identified, so that a reduction in the power consumption by the at least one wheel steering angle actuator can be omitted, or an early reactivation of normal operation can be achieved in these cases.

Furthermore, it is proposed that a health and/or wear condition of the at least one wheel steering angle actuator be taken into account when reducing the power consumption by the at least one wheel steering angle actuator. In this context, it is conceivable to, e.g., reduce power consumption only in the case of a wheel steering angle actuator with a poor or worse state of health and/or wear. Doing so can in particular increase the service life and/or durability of the vehicle.

A particularly high energy efficiency can be achieved in particular if a current power demand and/or a power demand by the at least one wheel steering angle actuator required in the driving situation is taken into account when reducing the power consumption by the at least one wheel steering angle actuator. In this context, it is conceivable to, e.g., reduce power consumption only in the case of a wheel steering angle actuator with a high or higher power demand.

In addition, it is proposed that a loading condition of the vehicle be taken into account when reducing the power consumption by the at least one wheel steering angle actuator. Since the load condition of the vehicle is directly linked to the power demand of the wheel steering angle actuators, a high load condition leads to, e.g., an increased power demand by the wheel steering angle actuators, and an asymmetrical load condition leads to a different power demand by the wheel steering angle actuators. Accordingly, by taking the load condition into account, a wheel steering angle actuator with a high power demand or greater power demand can be advantageously identified and a power consumption can optionally be reduced accordingly, thereby further improving an energy efficiency.

According to one embodiment, it is proposed that a first predefined driving situation corresponds to a driving process with a low steering demand, e.g., a trip at a low vehicle speed and a low lateral acceleration or a large cornering radius, and that a power consumption by a wheel steering angle actuator, in particular one of the two wheel steering angle actuators and/or exactly one wheel steering angle actuator, is reduced in order to reduce the energy demand and/or energy consumption. In particular, in this case only a power consumption by a portion of the wheel steering angle actuators is reduced. In this context, the wheel steering angle actuator whose power consumption is reduced can be, e.g., an inside-curve wheel steering angle actuator, an outside-curve wheel actuator angle actuator, a wheel steering angle actuator with a poorer state of health and/or wear, and/or a wheel steering angle actuator with a higher power demand. Furthermore, a yawing motion of the vehicle can be generated using the remaining wheel steering angle actuator, while the wheel steering angle actuator with reduced power consumption maintains a straight-ahead position, in particular by utilizing the chassis kinematics, or follows along in accordance with the yawing motion of the vehicle. In this way, energy demands and/or energy consumption can be reduced and efficiency can be advantageously increased, especially during driving operations with low steering demands, i.e., steering demands not equal to zero.

According to a further embodiment, it is proposed that a second predefined driving situation corresponds to a stopping process in which the vehicle is at a standstill and, in order to reduce the energy demand and/or energy consumption, a power consumption by both wheel steering angle actuators and preferably of all wheel steering angle actuators is reduced. In this way, energy demands and/or energy consumption can be reduced and efficiency advantageously increased, particularly during stops in which the vehicle is at a standstill.

It is also proposed that a third predefined driving situation corresponds to straight-ahead driving, i.e., a driving process with a steering demand equal to or close to zero and preferably at an increased vehicle speed, and a power consumption by both wheel steering angle actuators, preferably all wheel steering angle actuators, is reduced in order to reduce the energy demand and/or energy consumption. In this context, chassis kinematics, in particular in the form of castering, can again be exploited, whereby a return behavior of the vehicle axle due to the caster is speed-dependent and the vehicle wheels are increasingly better centered at an increasing vehicle speed. Doing so can in particular reduce energy demands and/or energy consumption, especially when driving straight ahead, and advantageously increase efficiency.

The method for reducing the energy demand and/or energy consumption by the vehicle is in the present context not intended to be limited to the application and embodiment described hereinabove. In particular, the method for reducing energy demand and/or energy consumption by the vehicle in order to achieve a mode of operation described herein can comprise a number of individual elements, components, and units different from the number described herein.

### BRIEF DESCRIPTION OF THE DRAWINGS

Further advantages will become apparent from the description of the drawings hereinafter. The drawings illustrate an exemplary embodiment of the disclosure.

Shown are:

FIGS. 1a-b a vehicle comprising a steer-by-wire steering system in a simplified illustration; and

FIG. 2 an exemplary flow chart with the main process steps of a method for reducing the energy demand and/or energy consumption by the vehicle.

### DETAILED DESCRIPTION

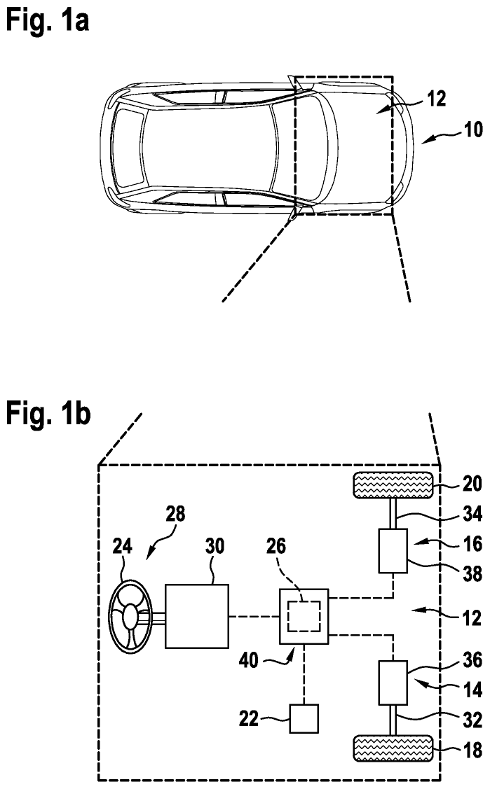

FIGS. 1a and 1b show a simplified illustration of a vehicle 10, which is, e.g., designed as a passenger vehicle comprising multiple vehicle wheels 18, 20 and comprising a steering system 12. The steering system 12 is operatively connected to the vehicle wheels 18, 20 and is provided to influence a direction of travel of the vehicle 10. Furthermore, the steering system 12 is designed as a steer-by-wire steering system, in which a steering command is electrically transmitted to the vehicle wheels 18, 20 in at least one operating state.

The steering system 12 comprises an inherently known operating unit 28. The operating unit 28 comprises a steering handle 24, e.g., in the form of a steering wheel, which can be operated in particular by a driver, and a feedback actuator 30, which is coupled in particular mechanically to the steering handle 24. In the present case, the feedback actuator 30 is provided at least for generating a steering resistance and/or a restoring torque on the steering handle 24. A steering handle could alternatively also be designed as a joystick, a steering lever, and/or as a steering ball, or the like. A feedback actuator could in principle also be omitted. It is also conceivable to completely omit an operating unit.

The steering system 12 further comprises multiple wheel steering angle actuators 14, 16. In the present case, the steering system 12 comprises, by way of example, two wheel steering angle actuators 14, 16, in particular a wheel steering angle actuator 14 and a further wheel steering angle actuator 16, designed as single wheel steering actuators and arranged on a vehicle axle designed as a front axle, and consequently, in particular, an individual wheel-based steering system. The wheel steering angle actuators 14, 16 are at least substantially structurally identical. The wheel steering angle actuators 14, 16 are designed separately from one another and in the present case are not mechanically connected. The wheel steering angle actuators 14, 16 can be actuated independently of one another. The wheel steering angle actuators 14, 16 are moreover connected to the operating unit 28 (and consequently the steering handle 24) only in an electrical manner. Each of the wheel steering angle actuators 14, 16 features an active connection to exactly one of the vehicle wheels 18, 20, in this case a front wheel (by way of example). The wheel steering angle actuators 14, 16 are provided to change a respective wheel steering angle of the corresponding vehicle wheel 18, 20 as a function of a steering command. For this purpose, each of the wheel steering angle actuators 14, 16 comprises a steering actuator element 32, 34, e.g. designed as a gear rack, and a steering actuator 36, 38 cooperating with the steering actuator element 32, 34 and designed as an electric motor. A steering system could in principle of course also comprise at least one wheel steering angle actuator designed as a central actuator. A steering system can furthermore also comprise at least four wheel steering angle actuators designed as single wheel steering actuators. A steering system could in principle also comprise a combination of a wheel steering angle actuator designed as a single wheel steering actuator and a wheel steering angle actuator designed as a central actuator. Moreover, at least one wheel steering angle actuator could in particular also be associated with a vehicle wheel designed as a rear wheel.

The vehicle 10 further comprises an inherently known vehicle sensor system 22 used for driving situation recognition. The vehicle sensor system 22 is provided in order to identify at least one, in particular current and/or future, driving situation and to provide a sensor signal correlated with the driving situation. In the present case, the vehicle sensor system 22 is provided at least for identifying at least one environmental variable and/or at least one operating variable of the vehicle 10. For example, camera data and/or road map data can be identified as an environmental variable, while, e.g., an operation of a vehicle pedal of the vehicle 10, an operation of a parking brake of the vehicle 10, a detection signal of an inertial sensor system of the vehicle 10, a vehicle speed, a steering handle deflection 24, a wheel steering angle, a gear rack position of the wheel steering angle actuators 14, 16, and/or a rotational wheel speed signal can be identified as an operational variable. For this purpose, the vehicle sensor system 22 can comprise at least one, in particular electrical, magnetic and/or optical, sensor element (not shown). Alternatively or additionally, the vehicle sensor system 22 can comprise a navigation system (not shown), e.g. including a GPS module. In addition, the vehicle sensor system 22 can comprise a communication module (not shown) for wireless communication with an external computer network, such as a cloud network, in which case the communication module can be used, e.g., to retrieve lane map data. In principle, however, it is also conceivable to completely omit a sensor element, a navigation system, and/or a communication module.

The vehicle 10 further comprises a control device 40. In the present case, the control device 40 is designed as a steering control device and is therefore part of the steering system 12. The control device 40 features an electrical connection to the operating unit 28. The control device 40 further features an electrical connection to the wheel steering angle actuators 14, 16. In addition, the control device 40 features an electrical connection to the vehicle sensor system 22. The control device 40 is provided at least for controlling operation of steering system 12.

The control device 40 features a computing unit 26. The computing unit 26 comprises at least one processor (not shown), e.g., in the form of a microprocessor, and at least one operating memory (not shown). Furthermore, the computing unit 26 comprises at least one operating program stored in the operating memory with at least one calculation routine, at least one identification routine, at least one evaluation routine and/or at least one actuation routine. A control device could in principle also be different from a steering control device and designed as, e.g., a single, central vehicle control device having a central computing unit. It is also conceivable to provide separate control devices for each wheel steering angle actuator and for the operating unit and connect them to one another in a communicative manner.

One disadvantage of single wheel steering actuators compared to a central actuator is that they have a higher overall energy demand or energy consumption. For example, in contrast to central actuators, single wheel steering actuators must provide actuator forces for both symmetrically and asymmetrically acting external forces in order to maintain a desired target position.

Therefore, in order to improve efficiency, a method for reducing an energy demand and/or energy consumption by the vehicle 10 is proposed hereinafter. In the present case, the method is described by way of example with reference to the vehicle wheels 18, 20 and the wheel steering angle actuators 14, 16 associated with the vehicle wheels 18, 20, although the following description can also be applied to further vehicle wheels, in particular on a further vehicle axle designed as a rear axle, and corresponding further wheel steering angle actuators. In the present case, the computing unit 26 is provided to perform the method and comprises for this purpose a computer program having corresponding program code means.

According to the disclosure, in at least one operating state in which a predefined driving situation is identified by means of the vehicle sensor system 22, a power consumption by at least one wheel steering angle actuator 14, 16 is reduced in order to reduce the energy demand and/or energy consumption. In this case, the at least one wheel steering angle actuator 14, 16 is actuated such that a power consumption by the at least one wheel steering angle actuator 14, 16 is reduced and is below a power consumption by the at least one wheel steering angle actuator 14, 16 planned for in the driving situation. In the operating state, active actuation of the at least one wheel steering angle actuator 14, 16 is omitted and a motor torque of the at least one wheel steering angle actuator 14, 16, in particular of the corresponding steering actuator 36, 38, is set to zero. Alternatively, however, at least one wheel steering angle actuator could also be at least temporarily deactivated and, for example, set to a standby mode and/or waiting mode. It is also conceivable to only reduce the power consumption by at least one wheel angle actuator so that at least a minimum steering functionality of the wheel angle actuator is maintained.

Furthermore, in the operating state, at least one environmental variable and/or at least one operating variable of the vehicle 10 is monitored and evaluated in order to identify a reactivation condition, the reactivation condition being used to reactivate a normal operation by the at least one wheel steering angle actuator 14, 16. In this context, the environmental variable and/or operating variable being monitored and/or evaluated in particular can also be selected and/or varied as a function of the respective driving situation. For example, camera data and/or road map data can be used as an environmental variable, whereas an actuation of the vehicle pedal, an actuation of the parking brake, a detection signal of the inertial sensor system, a vehicle speed, a deflection of the steering handle 24, a wheel steering angle, a gear rack position of the wheel steering angle actuators 14, 16, and/or a rotational wheel speed signal can be monitored as an operational variable.

Furthermore, in the present case, when normal operation of the at least one wheel steering angle actuator 14, 16 and in particular of a position regulator used to actuate the at least one wheel steering angle actuator 14, 16 is reactivated, a rate of increase of an engine torque is temporarily limited, in particular in the present case until a target position is reached, as a result of which driver annoyance during reactivation of normal operation can be prevented. Alternatively, however, a gain-scheduling approach could be used when reactivating normal operation by at least one wheel steering angle actuator.

Furthermore, at least one further environmental variable and/or at least one further operating variable of the vehicle 10, a course of a route of travel ahead, a cornering direction, a vehicle speed, a lateral acceleration of the vehicle 10, a state of health and/or wear of the at least one wheel steering angle actuator 14, 16, a current power demand and/or a power demand of the at least one wheel steering angle actuator 14, 16 required for the driving situation and/or a loading state of the vehicle 10 can be taken into account when reducing the power consumption by the at least one wheel steering angle actuator 14, 16. Similarly, when reactivating the normal operation of the at least one wheel steering angle actuator 14, 16, a course of the route of travel ahead, a cornering direction, a vehicle speed and/or a lateral acceleration of the vehicle 10 can also be taken into account in order to achieve a particularly anticipatory reactivation. Furthermore, a particularly efficient deactivation and/or reactivation of the at least one wheel steering angle actuator 14, 16 can be achieved in particular during an automated driving maneuver.

In the following, exemplary driving situations are described in which the method described hereinabove can be advantageously applied.

In this case, a first predefined driving situation can correspond to a driving process with a low steering demand, e.g., a trip with a low vehicle speed and a low lateral acceleration or a large cornering radius. In this case, in order to reduce energy demand and/or energy consumption, a power consumption by a single wheel steering angle actuator 14, 16, i.e., either the wheel steering angle actuator 14 or the further wheel steering angle actuator 16, can be reduced. In addition, yaw motion of the vehicle 10 can be generated using the remaining wheel steering angle actuator 14, 16, while the wheel steering angle actuator 14, 16 maintains a straight-ahead position at reduced power consumption, preferably by utilizing chassis kinematics, or follows along with the vehicle 10 in accordance with the yaw motion. Alternatively, however, in this case a power consumption by both wheel steering angle actuators could be reduced, and a yawing movement of the vehicle could be generated using a brake and/or ESP system. Further, due to a small phase offset between the remaining wheel steering angle actuator 14, 16 and the wheel steering angle actuator 14, 16 at reduced power consumption, the remaining wheel steering angle actuator 14, 16 or the track-guiding vehicle wheel 18, 20 coupled thereto may tend to be oversteered a bit when cornering is initiated in order to maintain unchanged agility of the vehicle 10. In order to improve an unobtrusiveness of the functionality in this case, a steering ratio, in particular a virtual steering ratio, between the steering handle 24 and the wheel steering angle actuators 14, 16 can be adjusted such that a steering behavior or driving behavior remains unchanged. Furthermore, by monitoring the environmental variables and/or the operating variables of the vehicle 10, e.g., camera data and/or the detection signal of the inertial sensor system, it is possible to intervene upon demand, e.g., in the event of a critical driving situation with higher driving dynamics, and optionally reactivate normal operation of the wheel steering angle actuator 14, 16 at a reduced power consumption.

In this context, the wheel steering angle actuator 14, 16 whose power consumption is reduced can be, e.g., an inside-curve wheel steering angle actuator or, alternatively, an outside-curve wheel steering angle actuator. In addition, the wheel steering angle actuator 14, 16 whose power consumption is reduced could be a wheel steering angle actuator with a poorer health and/or wear condition, which can advantageously increase a service life and/or durability of the vehicle 10. In order to identify a state of health and/or wear of the at least one wheel steering angle actuator 14, 16, a learning algorithm, e.g., in the form of an artificial intelligence means and particularly advantageously a recurrent neural network, can thereby be used. In addition, the wheel steering angle actuator 14, 16 whose power consumption is reduced could be a wheel steering angle actuator with a higher power demand. In this context, it must be taken into account that the loading condition of the vehicle 10 is directly linked to the power demand of the wheel steering angle actuators 14, 16 so that, e.g., an asymmetrical loading condition can lead to a different power demands by the wheel steering angle actuators 14, 16. The same applies in principle to chassis asymmetries.

A second predefined driving situation can correspond to a stopping process in which the vehicle 10 is at a standstill. In this case, in order to reduce the energy demand and/or energy consumption, a power consumption by both wheel steering angle actuators 14, 16, i.e., the wheel steering angle actuator 14 and the further wheel steering angle actuator 16, can be reduced. Alternatively, however, a power consumption by a single wheel steering angle actuator could be reduced in this case. For example, an actuation of a vehicle pedal, in particular a brake pedal, a rotational wheel speed signal, an actuation of a parking brake, a signal of a start-stop system and/or a red traffic light detected by means of a camera can be identified in order to recognize the stopping process. However, since there is a risk of the vehicle wheels 18, 20 turning automatically when the vehicle is stationary if the road is very slippery, it is important in this case to monitor the condition of the vehicle 10, for example the rotational wheel speed signals, and optionally to reactivate normal operation of the wheel steering angle actuators 14, 16. In addition, the aforementioned information can also be used to identify a friction value of the road surface or subgrade.

A third predefined driving situation can correspond to straight-ahead driving, i.e., driving with a steering demand equal to zero. In this case, in order to reduce the energy demand and/or energy consumption, a power consumption of both wheel steering angle actuators 14, 16, i.e., the wheel steering angle actuator 14 and the further wheel steering angle actuator 16, can be reduced. Alternatively, however, a power consumption by a single wheel steering angle actuator could be reduced in this case. In this case, chassis kinematics, in particular in the form of castering, can again be utilized, whereby a return behavior of the vehicle axle due to the caster is speed-dependent and the vehicle wheels 18, 20 are increasingly better centered at an increasing vehicle speed. Depending on the design of the vehicle 10, a geometry of a wheel suspension of the vehicle 10 can in this context also be adapted in order to enhance effects, e.g. self-centering. In this case, too, monitoring of the environmental variables and/or the operating variables of the vehicle 10 can be used to intervene as necessary and optionally reactivate normal operation by the wheel steering angle actuators 14, 16.

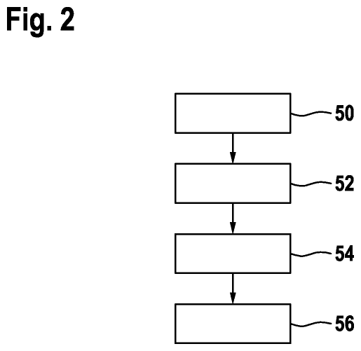

Finally, FIG. 2 shows an exemplary flow chart with main process steps of the method for reducing the energy demand and/or energy consumption by the vehicle 10.

In method step 50, a driving situation, in particular a current and/or future driving situation, is first identified and evaluated by means of the vehicle sensor system 22 in cooperation with the computing unit 26. If a predefined driving situation is detected in this context, in particular based a group of multiple predefined driving situations, then method step 52 follows.

In method step 52, a power consumption by at least one wheel steering angle actuator 14, 16 is reduced in order to reduce the energy demand and/or energy consumption, in particular such that the power consumption by the at least one wheel steering angle actuator 14, 16 is below a power consumption by the at least one wheel steering angle actuator 14, 16 planned for in the driving situation. In this case, active actuation of the at least one wheel steering angle actuator 14, 16 is omitted, and/or the at least one wheel steering angle actuator 14, 16 is at least temporarily deactivated.

Subsequently, in method step 54, at least one environmental variable and/or at least one operational variable of the vehicle 10 is monitored and evaluated. For example, camera data and/or road map data can be used as an environmental variable, whereas an actuation of the vehicle pedal, an actuation of the parking brake, a detection signal of the inertial sensor system, a vehicle speed, a deflection of the steering handle 24, a wheel steering angle, a gear rack position of the wheel steering angle actuators 14, 16, and/or a rotational wheel speed signal can be monitored as an operational variable. The environmental variable and/or operating variable to be monitored and/or evaluated in particular are selected and/or varied as a function of the respective driving situation. If a reactivation condition is identified during monitoring of the environmental variable and/or operational variable, then method step 56 follows.

In method step 56, a normal operation by the at least one wheel steering angle actuator 14, 16 is reactivated as a function of the reactivation condition. For this purpose, the reduction of the power consumption by the at least one wheel steering angle actuator 14, 16 is cancelled and the at least one wheel steering angle actuator 14, 16 is actively actuated again.

The exemplary flow chart in FIG. 2 is only intended to describe, by way of example, a method for reducing the energy demand and/or energy consumption by the vehicle 10. Individual method steps can in particular also vary, or additional method steps can be added. In this context, it is conceivable to, e.g., adjust a steering ratio between the steering handle 24 and the wheel steering angle actuators 14, 16 such that a steering behavior or driving behavior remains unchanged in the predefined driving situation. Furthermore, for example, when reactivating the normal operation of the at least one wheel steering angle actuator 14, 16, a rate of increase of an engine torque can be temporarily limited.

What is claimed is:

1. A method for reducing an energy demand and/or energy consumption by a vehicle, the vehicle including a steering system having at least two wheel steering angle actuators for changing a respective wheel steering angle of a vehicle wheel of the vehicle on an individual wheel basis, and a vehicle sensor system used for driving situation recognition, the method comprising:
reducing, in at least one operating state in which a predefined driving situation is identified using the vehicle sensor system, a power consumption by at least one wheel steering angle actuator of the at least two wheel steering angle actuators in order to reduce the energy demand and/or the energy consumption, such that the reduced power consumption by the at least one wheel steering angle actuator is below a power consumption by the at least one wheel steering angle actuator planned for in the identified predefined driving situation.

2. The method according to claim 1, further comprising:
omitting, in the at least one operating state, active actuation of the at least one wheel steering angle actuator, and/or
at least temporarily deactivating the at least one wheel steering angle actuator.

3. The method according to claim 1, further comprising:
monitoring and evaluating, in the at least one operating state, at least one environmental variable and/or at least one operating variable of the vehicle in order to identify a reactivation condition; and
using the reactivation condition to reactivate a normal operation of the at least one wheel steering angle actuator.

4. The method according to claim 1, further comprising:
adjusting, in the at least one operating state, a steering ratio between a steering handle of the steering system and the at least two wheel steering angle actuators, such that a steering behavior of the vehicle remains unchanged.

5. The method according to claim 3, further comprising:
reducing the power consumption by the at least one wheel steering angle actuator based on at least one further environmental variable, and/or at least one further operating variable of the vehicle.

6. The method according to claim 1, further comprising:
reducing the power consumption by the at least one wheel steering angle actuator based on a course of a preceding route of travel and/or a cornering direction of the vehicle.

7. The method according to claim 1, further comprising:
reducing the power consumption by the at least one wheel steering angle actuator based on a vehicle speed and/or a lateral acceleration of the vehicle.

8. The method according to claim 1, further comprising:
reducing the power consumption by the at least one wheel steering angle actuator based on a state of health and/or wear of the at least one wheel steering angle actuator.

9. The method according to claim 1, further comprising:
reducing the power consumption by the at least one wheel steering angle actuator based on a current power demand and/or a power demand by the at least one wheel steering angle actuator required in the identified predefined driving situation.

10. The method according to claim 1, further comprising:
reducing the power consumption by the at least one wheel steering angle actuator based on a loading state of the vehicle.

11. The method according to claim 1, wherein:
a first predefined driving situation corresponds to a driving operation with low steering demand, and
the power consumption by the wheel steering angle actuator is reduced in order to reduce the energy demand and/or energy consumption.

12. The method according to claim 11, wherein:
a second predefined driving situation corresponds to a stopping process in which the vehicle is at a standstill, and
a power consumption by the at least two wheel steering angle actuators is reduced in order to reduce the energy demand and/or energy consumption.

13. The method according to claim 12, wherein:
a third predefined driving situation corresponds to straight-ahead driving, and
a power consumption by the at least two wheel steering angle actuators is reduced in order to reduce the energy demand and/or energy consumption.

14. The method according to claim 1, wherein a computing unit is configured to perform the method.

15. A vehicle, comprising:
a plurality of vehicle wheels;
a steering system comprising at least two wheel steering angle actuators configured to change a respective wheel steering angle of the plurality of vehicle wheels on an individual wheel basis;
a vehicle sensor system configured for driving situation recognition; and
a computing unit configured to reduce an energy demand and/or energy consumption by the vehicle by, in at least one operating state in which a predefined driving situation is identified by the vehicle sensor system, reducing a power consumption by at least one wheel steering angle actuator of the at least two wheel steering angle actuators in order to reduce the energy demand and/or the energy consumption, such that the reduced power consumption by the at least one wheel steering angle actuator is below a power consumption by the at least one wheel steering angle actuator planned for in the identified predefined driving situation.
